(19) United States
(12) Patent Application Publication
(10) Pub. No.: US 2026/0071721 A1
(43) Pub. Date: Mar. 12, 2026

(54) Support Hanger for Trees and Bushes (Provisional patent filed as "Dugan's Heavy Hanger")

(71) Applicant: Jennifer Liciardello Dugan, Aston, PA (US)

(72) Inventor: Jennifer Liciardello Dugan, Aston, PA (US)

(21) Appl. No.: 18/827,731

(22) Filed: Sep. 7, 2024

(51) Int. Cl. F16M 13/02; A01G 17/10

(52) U.S. Cl. CPC F16M 13/022; A01G 17/10

(57) ABSTRACT

The Support Hanger for Trees and Bushes is a utilitarian item that can be used to hang items on trees or bushes. Heavier items often need a sturdy branch so that they don't sag or slide off the branch. The Support Hanger for Trees and Bushes allows the user to place their heavier item(s) in any place on the tree by using two adjacent branches to support the weight of the item(s). It can also be used to support branches that are hanging too low at the bottom of the tree to avoid bald spots within the tree.

### BACKGROUND

### Field of the Invention

The Support Hanger for Trees and Bushes is a solid cylinder with ends that are hooked around. It will be used to hang heavy items on trees or bushes by connecting two branches to displace the weight so the branches don't sag. It also includes a closed attachment piece to connect multiple support hangers to pair sagging branches at the bottom of the tree or bush with a stronger branch above to support the lower branch. A second version of the support hanger will include a support portion in the center with pins on both sides and two detached hooked sections that include holes for those pins. When connected by depressing the pins and inserting the support section into each of the hooked sections, the support hanger can be adjusted to various lengths.

### Description of the Related Art

There is currently nothing that is on the market that fills this need.

### SUMMARY

The Support Hanger for Trees and Bushes will make it easier to find the perfect spot on a tree or bush for any item, including the heavy ones, because it will pair branches to displace the weight of the hanging item to prevent sagging of branches.

The Support Hanger for Trees and Bushes will remove the need to cut off sagging branches at the bottom of the tree or bush by easily pairing the sagging branch with a stronger branch above to support the lower branch.

### BRIEF DESCRIPTION OF THE DRAWINGS

The first drawing shows the basic design of the Support Hanger for Trees and Bushes (FIG. 1). It will vary in length from 2 inches up to 10 inches. It will have a support section with curved hooked sections on both ends with a gap between the bottom of the hook at the main support section. Also shown are the top view (FIG. 1a) and side view (FIG. 1b).

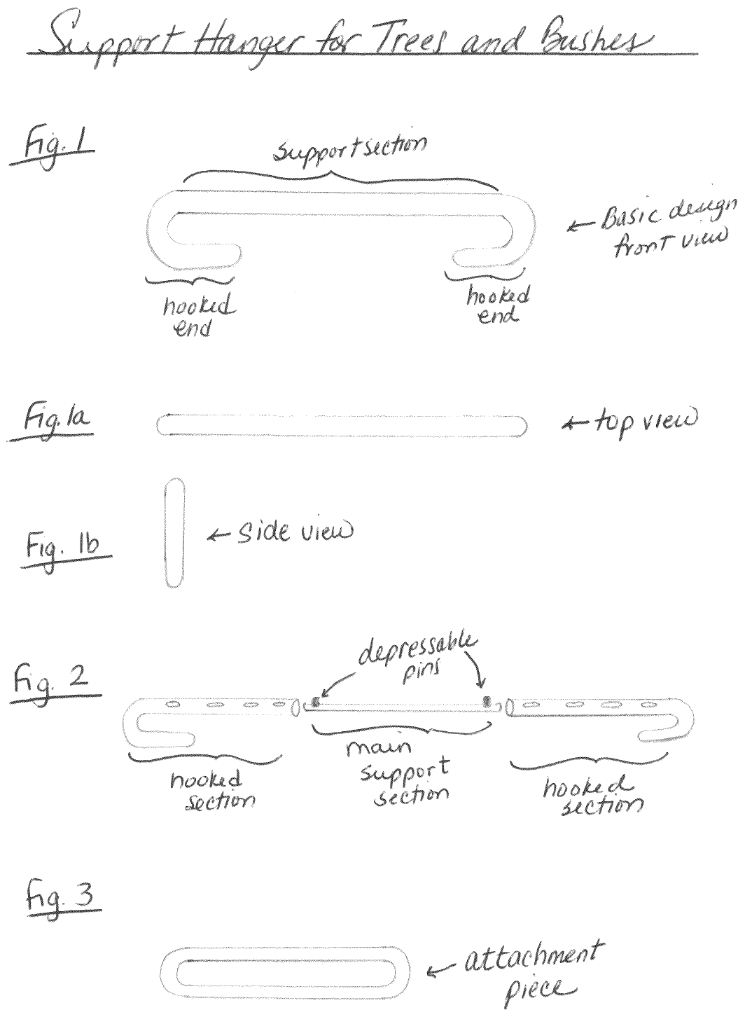

The second drawing shows the upgraded design that will be adjustable in length. It will contain a main support section that has a pin at each end and two hooked sections that have holes in which the pins will fit when the main section is inserted into each hooked section. By depressing the pins and pushing the main section farther into each hooked section, the length of the Support Hanger can be adjusted to fit the need of the user. These will also vary in length from 2 inches up to 10 inches. (FIG. 2)

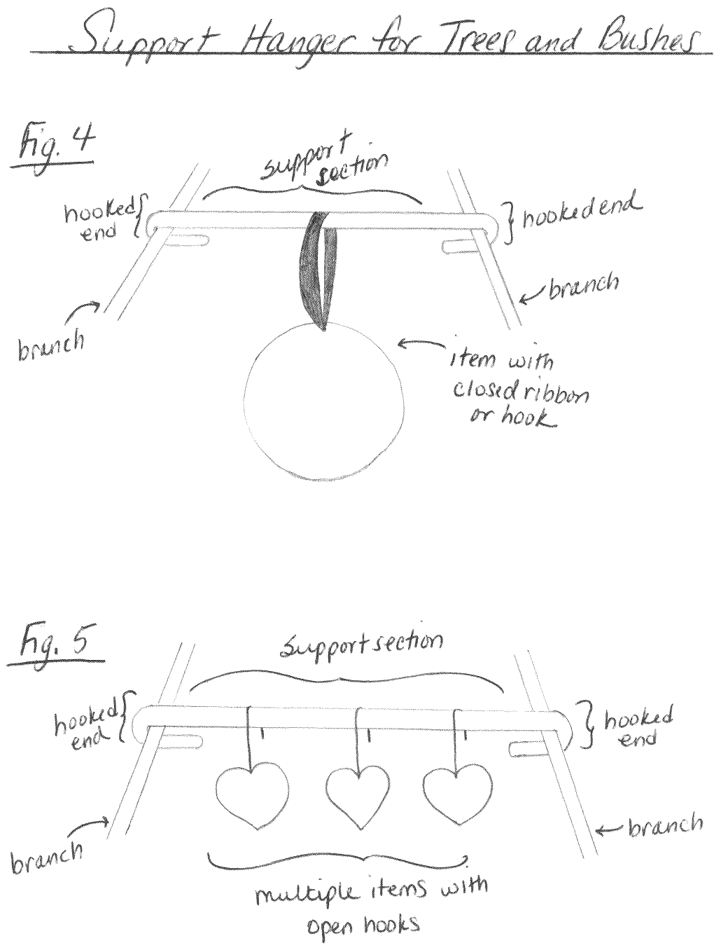

An attachment piece (FIG. 3) can be used to attach multiple support hangers together to achieve a greater length.

The support hanger can be used to support one or more items with closed ribbons or hooks (FIG. 4).

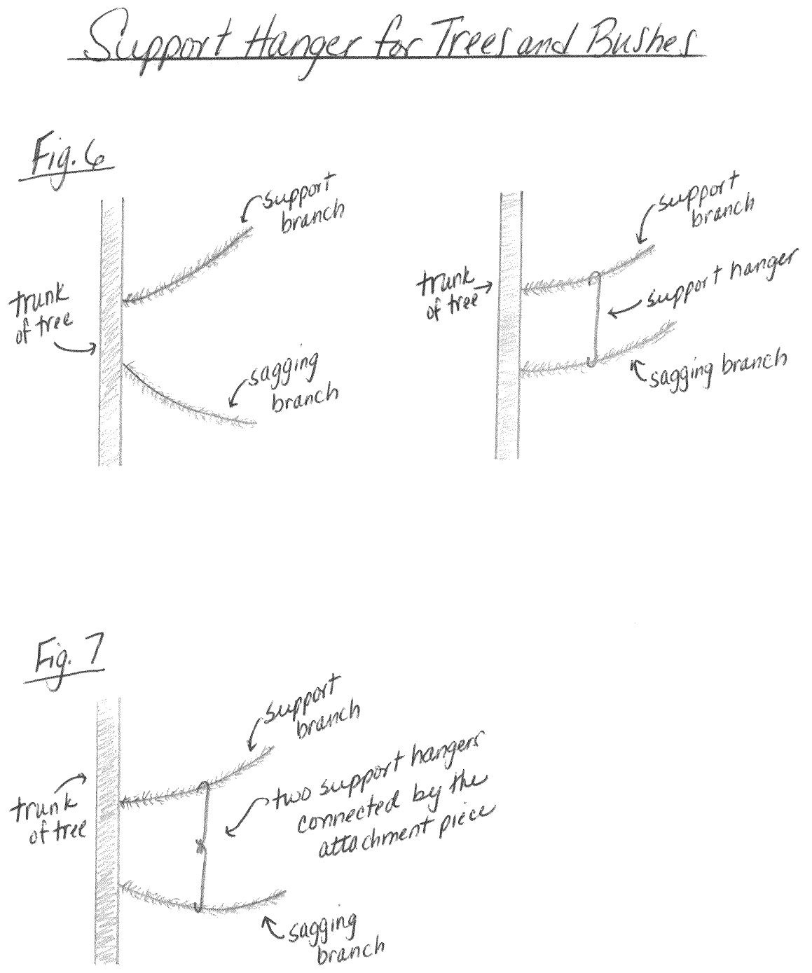

The support hanger can be used to support one or more items with open hooks (FIG. 5).

The support hanger can be used to support sagging branches by attaching the sagging branch to a support branch above (FIG. 6).

Two or more support hangers can be joined using the attachment piece in order to get a greater length to attach the sagging branch to the support branch (FIG. 7).

### DETAILED DESCRIPTION

The length of the support portion of the Support Hanger has a range of 2 inches to 10 inches with a diameter ranging from 0.125 inches to 2.5 inches. The length of the hooked portions have a range of 0.125 inches to 2.5 inches with a diameter ranging from 0.125 inches to 2.5 inches. The distance between the main support portion and the bottom of the hooked portion ranges from 0.125 to 2.5 inches.

Assuming the branches can support the weight, the larger Support Hangers from 5.5 inches to 10 inches will be able to support weights up to 15 pounds. Smaller support hangers up to 5.5 inches in length will be able to hold up to 5 pounds.

The attachment piece will be enclosed and will be oval, circular, or square in shape. It can be made of plastic, metal, wood, and composite materials and will be used to connect two Support Hangers. (FIG. 3)

The Support Hanger for Trees and Bushes can be used to hang one or more items on trees or bushes. For items that are hung by an enclosed hook or ribbon, the support hanger will need to be placed through the hook or ribbon first. Then, the Support Hanger should be hooked onto two adjacent branches on the tree or bush. This will allow both branches to support the weight of the item(s) and cause less sagging of the branches. (FIG. 4)

For items that are hung by open hooks, the Support Hanger can be hooked onto the desired adjacent branches first and then the item(s) can be hooked onto the Support Hanger. (FIG. 5)

For sagging branches at the bottom of the tree or bush, the Support Hanger for Trees and Bushes can be hooked onto the lower branch and then a stronger branch above to support the sagging branch. (FIG. 6)

Support Hangers can be paired together to create longer lengths if needed to support sagging branches. (FIG. 7)

1. A tree or bush hanger, comprising:
(a) a cylindrical apparatus made from plastic, wood, metal, or composite material having a support portion with hooked portions on each end, and
(b) when used to join two horizontally adjacent branches on trees or bushes, it will allow the user to hang larger, heavier items
(c) when used to join two vertically adjacent branches on trees or bushes with one or two joined by the attachment piece, it will support hanging branches eliminating bald spots in the tree or bush
